(19) United States
(12) Patent Application Publication
(10) Pub. No.: US 2014/0213195 A1
(43) Pub. Date: Jul. 31, 2014

(54) APPARATUS AND METHOD FOR ANALYZING EFFECT ON WIRELESS COMMUNICATION SYSTEM BY SOLAR COSMIC RADIO WAVE

(71) Applicant: Electronics and Telecommunications Research Institute, Daejeon (KR)

(72) Inventors: Yong Min LEE, Daejeon (KR); Cheol Oh JEONG, Gimpo (KR); Moon Hee YOU, Daejeon (KR); Jin Ho JO, Daejeon (KR)

(21) Appl. No.: 14/101,120

(22) Filed: Dec. 9, 2013

(30) Foreign Application Priority Data
Jan. 31, 2013 (KR) 10-2013-0011238

(51) Int. Cl. H04W 24/08

(52) U.S. Cl. CPC H04W 24/08
USPC 455/67.13

(57) ABSTRACT

Provided is an apparatus and method for analyzing an effect on a wireless communication system that may analyze an effect of a solar activity on a wireless communication system based on strength of solar cosmic radio waves. An apparatus for analyzing an effect on a wireless communication system may include a solar cosmic radio wave strength collecting unit to collect strength of solar cosmic radio waves according to a solar activity; and an interference determining unit to determine a level of interference of the solar activity against the wireless communication system, based on the strength of solar cosmic radio waves.

### CROSS-REFERENCE TO RELATED APPLICATION

This application claims the priority benefit of Korean Patent Application No. 10-2013-0011238, filed on Jan. 31, 2013, in the Korean Intellectual Property Office, the disclosure of which is incorporated herein by reference.

### BACKGROUND

1. Field of the Invention

The present invention relates to an apparatus and apparatus for analyzing an effect on a wireless communication system by solar cosmic radio waves, and more particularly, to an apparatus and method for analyzing an effect of a solar activity against a wireless communication system based on strength of solar cosmic radio waves.

2. Description of the Related Art

In a case in which a solar activity such as an explosion of sunspot occurs, an amount of magnetic energy emitted from the sun increases and thus, solar cosmic radio waves interfering with radio waves may occur.

Here, the solar cosmic radio waves may disturb the ionosphere of the earth, which may result in causing the fluctuation of radio signals used by a wireless communication system and an anomalous propagation phenomenon. In addition, due to a radio burst by the solar cosmic radio waves, the electron density of the ionosphere may vary and thus, a global positioning system (GPS) signal may have a position error of a few meters to a few kilometers.

Accordingly, there is a need for a method that, in a case in which a solar activity occurs, may analyze in advance an effect of the solar activity on a wireless communication system and thereby perform an alert before the energy emitted from the sun reaches the earth and thereby a radio burst occurs.

### SUMMARY

An aspect of the present invention provides an apparatus and method that may predict an effect of solar cosmic radio waves, having increased due to a solar activity, with respect to a wireless communication system using strength of solar cosmic radio waves.

Another aspect of the present invention also provides an apparatus and method that may provide a user or a manager with prediction information or alert information about the above probability, based on the prediction result, thereby enabling the user or the manager to prepare for a damage by the solar activity and to recognize from which the damage is originated.

According to an aspect of the present invention, there is provided an apparatus for analyzing an effect on a wireless communication system, the apparatus including: a solar cosmic radio wave strength collecting unit to collect strength of solar cosmic radio waves according to a solar activity; and an interference determining unit to determine a level of interference of the solar activity against the wireless communication system, based on the strength of solar cosmic radio waves.

The interference determining unit may include: a degradation calculator to calculate a degradation in a signal-to-noise ratio (SNR) of the wireless communication system based on the strength of solar cosmic radio waves; a maximum channel noise level determining unit to determine a maximum channel noise level of the wireless communication system based on a reception power level and the SNR of the wireless communication system; and a link margin calculator to calculate a link margin of the wireless communication system varying according to the solar activity, based on a reception sensitivity of the wireless communication system according to the maximum channel noise level, the reception power level, and the degradation.

The degradation calculator may calculate the degradation based on a relationship among the strength of solar cosmic radio waves, a receive antenna gain of the wireless communication system, an operating frequency of the wireless communication system, and a noise temperature of the wireless communication system.

The interference determining unit may include an interference information providing unit to determine a level of interference of the solar activity against the wireless communication system by comparing a link margin of the wireless communication system varying according to the solar activity and an allowable link margin of the wireless communication system, and to provide a user with interference information based on a determination result.

The interference information may include at least one of alert information indicating a probability that the interference of the solar activity against the wireless communication system is likely to damage the wireless communication system, and prediction information indicating a level of interference of the solar activity against the wireless communication system and a time of the interference.

According to another aspect of the present invention, there is provided a method of analyzing an effect on a wireless communication system, the method including: collecting strength of solar cosmic radio waves according to a solar activity; and determining a level of interference of the solar activity against the wireless communication system, based on the strength of solar cosmic radio waves.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a diagram illustrating an operation of an effect analyzing apparatus according to an embodiment of the present invention;

FIG. 2 is a block diagram illustrating an effect analyzing apparatus according to an embodiment of the present invention;

FIG. 3 is a block diagram illustrating an interference determining unit of FIG. 2 according to an embodiment of the present invention;

FIG. 4 is a flowchart illustrating a method of analyzing an effect on a wireless communication system according to an embodiment of the present invention;

FIG. 5 is a flowchart illustrating an operation of determining a level of interference of FIG. 4 according to an embodiment of the present invention.

### DETAILED DESCRIPTION

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures.

Hereinafter, embodiments of the present invention will be described in detail with reference to the accompanying drawings. A method of analyzing an effect on a wireless communication system according to an embodiment of the present invention may be performed by an effect analyzing apparatus according to an embodiment of the present invention.

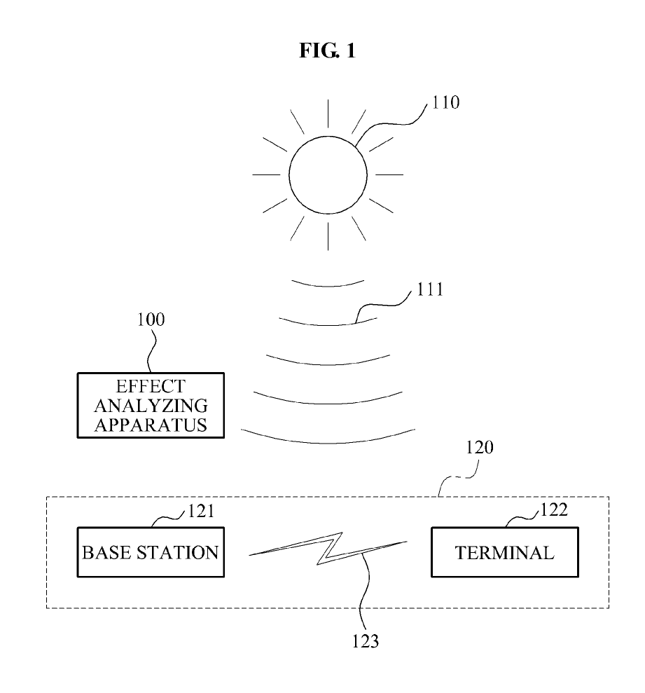

FIG. 1 is a diagram illustrating an operation of an effect analyzing apparatus 100 according to an embodiment of the present invention.

Solar cosmic radio waves 111 coming from the cosmic space to the earth may interfere with radio waves 123 used by a wireless communication system 120 for wireless communication.

Here, the cosmic radio waves 111 may refer to radio waves emitted from the celestial bodies scattered over the cosmic space. Among the solar cosmic radio waves 111, the strongest radio wave may be a solar cosmic radio wave that occurs due to a solar flare among a variety of factors emitted from the sun 110.

Accordingly, when the solar flare and corona mass ejection (CME) reach the earth due to a solar activity such as an explosion of sunspot, strength of solar cosmic radio waves may increase and thus, become a cause of interfering with the radio waves 123 on the ground. Here, a few seconds to a few days may be used when factors capable of affecting the ground wireless communication system 120, such as the solar flare, CME, and corona hall, reach the earth. An affecting duration may differ for each factor, such as one or two hours to a few days, which causes a radio burst that directly affects wireless communication between the sun 110 and the earth.

For example, a base station 121 and a terminal 122 of the wireless communication system 120 may usually communicate with each other using the radio waves 123 that are generated based on the solar cosmic radio waves 111. The radio waves 123 may refer to waves in which information required for communication does not receive interference by the solar cosmic radio waves 111 usually coming from the sun 110 to the earth. The wireless communication system 120 may include a plurality of apparatuses configured to wirelessly perform communication. For example, the wireless communication system 120 may be a system including the base station 121 and the terminal 122 of FIG. 1, and may also be a satellite communication system such as a global positioning system (GPS) terminal and a satellite, or a system using waves such as a radar.

However, when a solar activity occurs, strength of the solar cosmic radio waves 111 may increase and thus, interference of the solar cosmic radio waves 111 against the radio waves 120 may increase. When the interference of the solar cosmic radio waves 111 increases, a probability that information required for communication is likely to be damaged by the interference may also increase.

Accordingly, the effect analyzing apparatus 100 according to an embodiment of the present invention may predict an occurrence of radio burst before the radio burst occurs and interference information of the wireless communication system 120 based on the occurrence of the radio burst by determining a level of interference of the solar activity against the wireless communication system 120 based on the strength of solar cosmic radio waves associated with the solar activity. The effect analyzing apparatus 100 may prevent a malfunction of and damage to the wireless communication system 120 by alerting or forecasting the occurrence of radio burst before the radio burst occurs, based on the prediction result.

For example, strength of solar cosmic radio waves may be a value obtained when a solar cosmic radio wave observing apparatus measures electromagnetic waves of 2,800 MHz frequency emitted from the sun, and may be measured based on a solar flux unit (SFU).

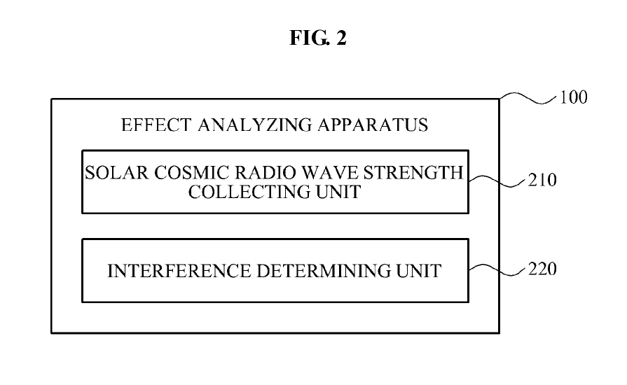

FIG. 2 is a block diagram illustrating the effect analyzing apparatus 100 according to an embodiment of the present invention.

Referring to FIG. 2, the effect analyzing apparatus 100 may include a solar cosmic radio wave strength collecting unit 210 and an interference determining unit 220. The solar cosmic radio wave strength collecting unit 210 may collect strength of solar cosmic radio waves according to a solar activity.

The solar cosmic radio wave strength collecting unit 210 may receive the strength of solar cosmic radio waves 111 collected from domestic and foreign solar cosmic radio wave observing institutions using a solar cosmic radio wave observing apparatus.

The interference determining unit 220 may determine a level of interference of the solar activity against the wireless communication system 120, based on the strength of solar cosmic radio waves 111 collected by the solar cosmic radio wave strength collecting unit 210.

For example, the interference determining unit 220 may determine a level of interference of solar cosmic radio waves 111, having increased due to the solar activity, with respect to the wireless communication system 120, based on the strength of solar cosmic radio waves 111, and may provide interference information to a user or a manager of the wireless communication system 120. Here, the interference information may include at least one of alert information indicating a probability that the solar activity is likely to damage the wireless communication system 120, and prediction information indicating a level of interference of the solar activity and a time of the interference.

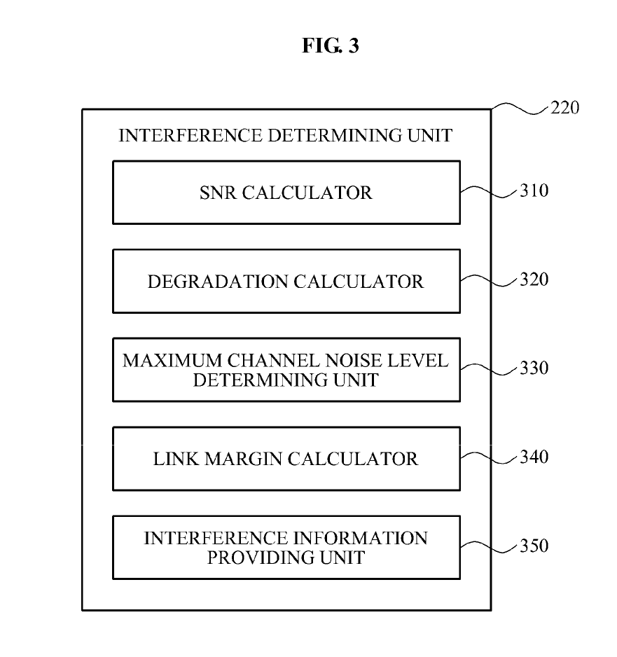

Hereinafter, the overall configuration and operation of the interference determining unit 220 will be described with reference to FIG. 3.

FIG. 3 is a block diagram illustrating the interference determining unit 220 of FIG. 2 according to an embodiment of the present invention

Referring to FIG. 3, the interference determining unit 220 may include a signal-to-noise ratio (SNR) calculator 310, a degradation calculator 320, a maximum channel noise level determining unit 330, a link margin calculator 340, and an interference information providing unit 350.

The SNR calculator 310 may calculate an SNR of a state in which the wireless communication system 120 does not receive interference by the solar cosmic radio waves 111, based on an operating frequency of the wireless communication system 120, a transmitter output, a transmit antenna gain, a coverage radius, a receive antenna gain, a modulation scheme, and a coding rate.

Here, the SNR calculator 310 may calculate a free space radio loss of radio waves 123 and a reception power level, and may calculate the SNR of the wireless communication system 120 using a method that is differently defined based on the modulation scheme, the coding rate, and the like of the wireless communication system 120.

The SNR calculator 310 may calculate an SNR of the wireless communication system 120 by applying additional loss, such as multipath fading, based on a propagation environment of the wireless communication system 120. Also, the SNR calculator 310 may calculate a reception power level of a wireless communication receiver according to Equation 1.

[Equation 1]

Reception power level=transmitter output+transmit antenna gain+receive antenna gain−free space loss

The degradation calculator 320 may calculate a degradation in the SNR of the wireless communication system 120 based on the strength of solar cosmic radio waves 111 collected by the solar cosmic radio wave strength collecting unit 210. Here, the degradation in the SNR of the wireless communication system 120 may indicate a level of change in the SNR of the wireless communication system 120 calculated by the SNR calculator 310, which occurs due to the interference of the solar cosmic radio waves 111.

For example, the degradation calculator 320 may calculate the degradation in the

SNR of the wireless communication system 120 according to Equation 2.

[Equation 2]

SNR degradation level (dB)=10 log₁₀[1.0+(S_{b} G c²)/(4 πf² k Tₛ)]

In Equation 2, S_{b} denotes the strength of solar cosmic radio waves 111 collected by the solar cosmic radio wave strength collecting unit 210, G denotes the receive antenna gain of the wireless communication system 120, and c denotes the velocity of light. Also, f denotes an operating frequency of the wireless communication system 120, k denotes Boltzmann constant, and Tₛ denotes system noise temperature. The system noise temperature may be thermal noise occurring due to the heat generated during an operation of the wireless communication system 120.

The maximum channel noise level determining unit 330 may determine a maximum channel noise level of the wireless communication system 120 based on a reception power level and the SNR of the wireless communication system 120.

For example, the maximum channel noise level determining unit 330 may determine, as the maximum channel noise level, a value obtained by subtracting the SNR of the wireless communication system 120 from the reception power level of the wireless communication system 120 calculated by the SNR calculator 310.

The link margin calculator 340 may calculate a link margin of the wireless communication system 120 varying according to the solar activity. The link margin of the wireless communication system 120 varying according to the solar activity may be a link margin in a case in which the wireless communication system 120 receives interference by the solar cosmic radio waves 111.

For example, the link margin calculator 340 may calculate the link margin of the wireless communication system 120 varying according to the solar activity, based on a reception sensitivity of the wireless communication system 120, the reception power level, and the degradation of the wireless communication system 120. Here, the link margin calculator 340 may determine, as the reception sensitivity of the wireless communication system 120, a value by 3 dB greater than the maximum noise level determined by the maximum channel noise level determining unit 330.

For example, the link margin calculator 340 may calculate the link margin of the wireless communication system 120 varying according to the solar activity, using Equation 3.

[Equation 3]

Link margin=reception power level−reception sensitivity−degradation of wireless communication system

The interference information providing unit 350 may determine a level of interference of the calculated link margin against the wireless communication system 120, and may provide interference information according to the determination result to a user using the wireless communication system 120 or a manager of the wireless communication system 120.

Here, the interference information providing unit 350 may determine a level of interference of the solar activity against the wireless communication system 120 by comparing the link margin of the wireless communication system 120 varying according to the solar activity and an allowable link margin of the wireless communication system 120. Specifically, the interference information providing unit 350 may determine the level of interference against the wireless communication system 120 by setting a safe region, an attention region, a dangerous region, and the like, based on the allowable link margin for each wireless communication system 120, and by determining whether the link margin calculated by the link margin calculator 340 corresponds to any one of the safe region, the attention region, and the dangerous region of the wireless communication system 120.

The interference information providing unit 350 may provide interference information according to the determination result to the user using the wireless communication system 120 or the manager of the wireless communication system 120.

For example, when the link margin corresponds to the safe region, the interference information providing unit 350 may not provide the interference information. Also, when the link margin corresponds to the dangerous region, the interference information providing unit 350 may provide the user or the manager, as interference information, with alert information indicating that the solar cosmic radio waves 111 are highly likely to damage the wireless communication system 120. When the link margin corresponds to the attention region, the interference providing unit 350 may provide the user or the manager with interference information including alert information indicating a damage probability of the solar cosmic radio waves 111 against the wireless communication system, and prediction information indicating a level of interference of the solar cosmic radio waves 111 and a time of the interference.

When the solar cosmic radio waves 111 are likely to damage the wireless communication system 120, the interference information providing unit 350 may provide the user or the manager with prediction information or alert information in association with such damage probability. Accordingly, the user and the manager may be enabled to prepare for the damage by the solar activity or recognize the cause of damage in advance.

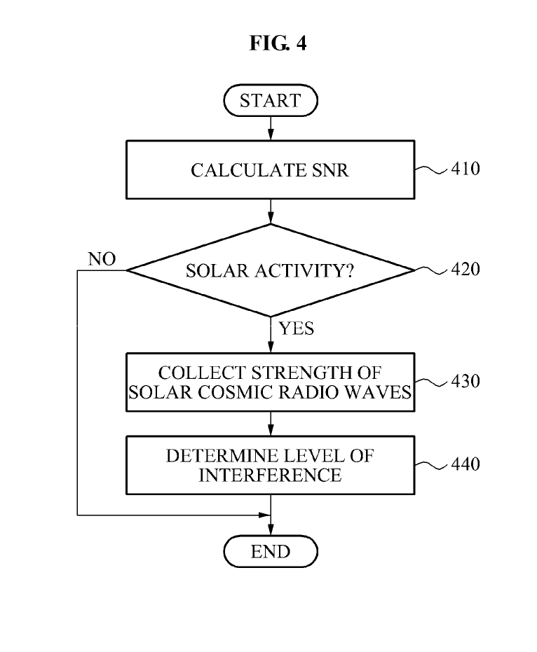

FIG. 4 is a flowchart illustrating a method of analyzing an effect on the wireless communication system 120 according to an embodiment of the present invention.

In operation 410, the SNR calculator 310 may calculate an SNR of a state in which the wireless communication system 120 does not receive interference by the solar cosmic radio waves 111, based on an operating frequency of the wireless communication system 120, a transmitter output, a transmit antenna gain, a coverage radius, a receive antenna gain, a modulation scheme, and a coding rate.

Here, the SNR calculator 310 may calculate a free space radio loss of radio waves 123 and a reception power level, and may calculate the SNR of the wireless communication system 120 using a method that is differently defined based on the modulation scheme, the coding rate, and the like of the wireless communication system 120.

In operation 420, the solar cosmic radio wave strength collecting unit 210 may verify whether the solar activity has occurred. For example, the solar cosmic radio wave strength collecting unit 210 may receive information indicating the occurrence of the solar activity such as explosion of sunspot from a solar cosmic radio wave observing apparatus. When information indicating the occurrence of the solar activity is not received, the solar cosmic radio wave strength collecting unit 210 may terminate an operation. Conversely, when information indicating the occurrence of the solar activity is received, the solar cosmic radio wave strength collecting unit 210 may perform operation 430.

In operation 430, the solar cosmic radio wave strength collecting unit 210 may collect strength of solar cosmic radio waves 111 according to the solar activity.

Here, the solar cosmic radio wave strength collecting unit 210 may receive the strength of solar cosmic radio waves 111 collected from domestic and foreign solar cosmic radio wave observing institutions using a solar cosmic radio wave observing apparatus.

In operation 440, the interference determining unit 220 may determine a level of interference of the solar activity against the wireless communication system 120, based on the strength of solar cosmic radio waves 111 collected in operation 430.

For example, the interference determining unit 220 may determine a level of interference of solar cosmic radio waves 111, having increased due to the solar activity, with respect to the wireless communication system 120, based on the strength of solar cosmic radio waves 111.

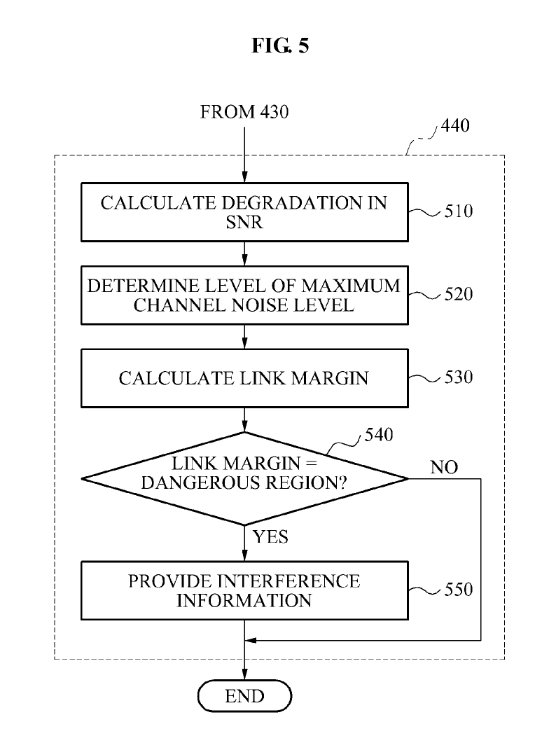

FIG. 5 is a flowchart illustrating operation 440 of determining a level of interference of FIG. 4 according to an embodiment of the present invention. Operations 510 through 550 may be included in operation 440 of FIG. 4.

In operation 510, the degradation calculator 320 may calculate a degradation in the SNR of the wireless communication system 120 based on the strength of solar cosmic radio waves 111 collected in operation 430. Here, the degradation in the SNR of the wireless communication system 120 may indicate a level of change in the SNR of the wireless communication system 120 calculated in operation 410, which occurs due to the interference of the solar cosmic radio waves 111.

In operation 520, the maximum channel noise level determining unit 330 may determine a maximum channel noise level of the wireless communication system 120 based on a reception power level and the SNR of the wireless communication system 120.

For example, the maximum channel noise level determining unit 330 may determine the maximum channel noise level based on a difference between the reception power level of the wireless communication system 120 and the SNR of the wireless communication system 120 calculated in operation 410.

In operation 530, the link margin calculator 340 may calculate a link margin of the wireless communication system 120 varying according to the solar activity.

For example, the link margin calculator 340 may calculate the link margin of the wireless communication system 120 varying according to the solar activity, based on a reception sensitivity of the wireless communication system 120, the reception power level calculated in operation 410, and the degradation of the wireless communication system 120 calculated in operation 510. Here, the link margin calculator 340 may determine, as the reception sensitivity of the wireless communication system 120, a value by 3 dB greater than the maximum noise level determined in operation 520.

In operation 540, the interference information providing unit 350 may determine whether the link margin calculated in operation 530 corresponds to a dangerous region of the wireless communication system 120.

Here, when the link margin calculated in operation 530 does not correspond to a dangerous region of the wireless communication system 120, the interference information providing unit 350 may terminate an operation. Conversely, when the link margin calculated in operation 530 corresponds to the dangerous region of the wireless communication system 120, the interference information providing unit 350 may perform operation 550.

In operation 550, the interference information providing unit 350 may provide interference information according to the determination result to a user using the wireless communication system 120 or a manager of the wireless communication system 120.

For example, when the link margin corresponds to the dangerous region, the interference information providing unit 350 may provide the user or the manager, as the interference information, with alert information indicating that the solar cosmic radio waves 111 are highly likely to damage the wireless communication system 120.

Also, in operation 540, whether the link margin corresponds to an attention region may be determined When the link margin corresponds to the attention region, the interference information providing unit 350 may provide the user or the manager with interference information including alert information indicating a damage probability of the solar cosmic radio waves 111 against the wireless communication system 120, and prediction information indicating a level of interference of the solar cosmic radio waves 111 and a time of the interference.

According to embodiments of the present invention, it is possible to predict an effect of solar cosmic radio wave, having increased due to a solar activity, with respect to a wireless communication system using strength of solar cosmic radio wave.

Also, according to embodiments of the present invention, it is possible to provide a user or a manager with prediction information or alert information about the above probability, based on the prediction result, thereby enabling the user or the manager to prepare for a damage by the solar activity and to recognize from which the damage is originated.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. An apparatus for analyzing an effect on a wireless communication system, the apparatus comprising:
a solar cosmic radio wave strength collecting unit to collect strength of solar cosmic radio waves according to a solar activity; and
an interference determining unit to determine a level of interference of the solar activity against the wireless communication system, based on the strength of solar cosmic radio waves.

2. The apparatus of claim 1, wherein the interference determining unit comprises:
a degradation calculator to calculate a degradation in a signal-to-noise ratio (SNR) of the wireless communication system based on the strength of solar cosmic radio waves;
a maximum channel noise level determining unit to determine a maximum channel noise level of the wireless communication system based on a reception power level and the SNR of the wireless communication system; and
a link margin calculator to calculate a link margin of the wireless communication system varying according to the solar activity, based on a reception sensitivity of the wireless communication system according to the maximum channel noise level, the reception power level, and the degradation.

3. The apparatus of claim 2, wherein the degradation calculator calculates the degradation based on a relationship among the strength of solar cosmic radio waves, a receive antenna gain of the wireless communication system, an operating frequency of the wireless communication system, and a noise temperature of the wireless communication system.

4. The apparatus of claim 1, wherein the interference determining unit comprises:
an interference information providing unit to determine a level of interference of the solar activity against the wireless communication system by comparing a link margin of the wireless communication system varying according to the solar activity and an allowable link margin of the wireless communication system, and to provide a user with interference information based on a determination result.

5. The apparatus of claim 1, wherein the interference information comprises at least one of alert information indicating a probability that the interference of the solar activity against the wireless communication system is likely to damage the wireless communication system, and prediction information indicating a level of interference of the solar activity against the wireless communication system and a time of the interference.

6. A method of analyzing an effect on a wireless communication system, the method comprising:
collecting strength of solar cosmic radio waves according to a solar activity; and
determining a level of interference of the solar activity against the wireless communication system, based on the strength of solar cosmic radio waves.

7. The method of claim 6, wherein the determining comprises:
calculating a degradation in a signal-to-noise ratio (SNR) of the wireless communication system based on the strength of solar cosmic radio waves;
determining a maximum channel noise level of the wireless communication level based on a reception power level and the SNR of the wireless communication system; and
calculating a link margin of the wireless communication system varying according to the solar activity, based on a reception sensitivity of the wireless communication system according to the maximum channel noise level, the reception power level, and the degradation.

8. The method of claim 7, wherein the calculating of the degradation comprises calculating the degradation based on a relationship among the strength of solar cosmic radio waves, a receive antenna gain of the wireless communication system, an operating frequency of the wireless communication system, and a noise temperature of the wireless communication system.

9. The method of claim 6, wherein the determining of the interference comprises:
determining a level of interference of the solar activity against the wireless communication system by comparing a link margin of the wireless communication system varying according to the solar activity and an allowable link margin of the wireless communication system; and
providing a user with interference information based on a determination result.

10. The method of claim 6, wherein the interference information comprises at least one of alert information indicating a probability that the interference of the solar activity against the wireless communication system is likely to damage the wireless communication system, and prediction information indicating a level of interference of the solar activity against the wireless communication system and a time of the interference.
